(19) United States
(12) Patent Application Publication
(10) Pub. No.: US 2009/0085244 A1
(43) Pub. Date: Apr. 2, 2009

(54) METHOD FOR REMOVING SOLVENT FROM POLYMER SOLUTION

(76) Inventors: Yukihiro Katai, Kanagawa (JP); Takuro Nishimura, Kanagawa (JP)

Correspondence Address: BIRCH STEWART KOLASCH & BIRCH, PO BOX 747, FALLS CHURCH, VA, 22040-0747, US

(21) Appl. No.: 12/239,655

(22) Filed: Sep. 26, 2008

(30) Foreign Application Priority Data
Sep. 28, 2007 (JP) 2007-254309

(51) Int. Cl. B29D 7/01

(52) U.S. Cl. 264/204

(57) ABSTRACT

A dope containing a TAC and solvent is prepared in a dope producing apparatus. In a case where a new dope having components different from that of the dope described above is produced, a controlling device performs controlling such that an operation of each pump is stopped, each valve is set to a closing position, and a hopper stops supplying the TAC. Thereafter, a washing liquid is introduced into the respective devices of the dope producing apparatus. The dope remained in the respective devices are discharged as a waste liquid together with the washing liquid. The waste liquid is heated in dry gas until a liquid level of the waste liquid turns into a falling-rate drying state in a dry heating chamber provided in a solvent removing device. In a wet heating chamber, the waste liquid is heated in wet gas.

### FIELD OF THE INVENTION

The present invention relates to a method for removing solvent from a polymer solution, and in particular to a method for removing solvent from waste discharged from a dope producing apparatus, a solution casting apparatus, or the like.

### BACKGROUND OF THE INVENTION

A polymer film (hereinafter referred to as film) has advantages such as excellent light transmission properties and flexibility, and is easy to be made lighter and thinner. Accordingly, the film is widely used as an optical functional film. As a representative of the film, a triacetyl cellulose (TAC) film using cellulose acylate (especially, triacetyl cellulose (TAC) with an average acetylation degree in the range of 57.5 to 62.5%) has toughness and flame retardancy, and therefore the TAC film is utilized as a film base of photosensitive material. Additionally, since the TAC film has an excellent optical isotropy, the TAC film is utilized as an optical functional film such as a protective film for a polarizing filter in a LCD and the like whose market is increasingly expanded recently.

As a film production method, mainly, there are a melt-extrusion method and a solution casting method. In the melt-extrusion method, a polymer is heated to be melted, and then extruded by an extruder, to form a film. The melt-extrusion method has advantages such as high productivity and relatively low equipment cost. However, in the melt-extrusion method, it is difficult to adjust thickness accuracy of the film, and further fine streaks (die lines) easily occur on the film. Accordingly, it is difficult to produce a film having high quality as an optical functional film. On the contrary, in the solution casting method, a polymer solution (hereinafter referred to as a dope) containing a polymer and a solvent is cast onto a support to form a casting film. The casting film is hardened enough to have strength for self-supporting property, and peeled from the support to form a wet film. The wet film is dried and wound as a film. In the solution casting method, it is possible to obtain a film having more excellent optical isotropy and thickness evenness and containing less foreign substances in comparison with the melt-extrusion method. Therefore, the solution casting method is adopted as a producing method of a film, in particular, an optical functional film (for example, see in Japanese Patent Laid-Open Publication No. 2006-306052).

Each device for use in a dope producing apparatus and a solution casting apparatus need to be washed periodically. For example, at a filtration device, when filtration members are exchanged with new ones, in order to remove the dope and foreign substances remained in the filtration device therefrom, an inside of the filtration device is washed with use of a washing liquid. As a washing agent for the filtration device and the like, solvent contained in the dope is used. Therefore, at the time of washing each device for use in the dope producing apparatus and the solution casting apparatus, waste containing the solvent, the remained dope and substances, and the like is produced.

Further, in a casting chamber and a drying chamber provided in the solution casting apparatus, a casting film and a wet film are dried to evaporate the solvent therefrom in a drying process. Due to the drying process, gas containing the solvent is produced. A recovery device provided in the casting chamber and the drying chamber recovers and cools the gas, and then the waste containing the solvent is produced from the gas.

The solvent used in the solution casting method contains a compound such as dichloromethane which cannot be discarded without any process in many cases. Moreover, a large amount of the waste containing the solvent is produced in the washing process of the filtration device and the like, the drying process in the solution casting method, and the like. Additionally, a large amount of solvent is necessary in the solution casting method. In view of the above, the solvent is drawn from the waste produced in the washing process, the drying process, and the like, and the drawn solvent is reused in the solution casting method and the like. Accordingly, prevention of environmental contamination such as air pollution and cost reduction in the solution casting method are simultaneously achieved (see Japanese Patent Laid-Open Publication No. 2003-236863). In a method disclosed in Japanese Patent Laid-Open Publication No. 2003-236863, a predetermined amount of polymer and solvent are added to a waste dope having the same components as those of a new dope to achieve a desired component ratio of the new dope.

Due to recent development, various kinds of LCDs such as TN type LCD and VA type LCD are produced, and TAC film is applied not only to a protective film but also to an optical compensation film, a wide view film, and the like. Accordingly, various kinds of TAC films have been required. Therefore, in a case where various kinds of TAC films are produced in a single solution casting apparatus, it is necessary to perform so-called dope changing. In the dope changing, after the dope and the like remained in the filtration device, the pipes, the solution casting apparatus, and the like are removed therefrom by the washing agent or the like, a new dope is poured into the filtration device, the pipes, the solution casting apparatus, and the like.

In the dope changing, in the case of forming a new dope from a waste dope having different components from those of the new dope, the method disclosed in Japanese Patent Laid-Open Publication No. 2003-236863 cannot be adopted without any modifications. Therefore, in the case of changing the waste dope to a new dope each having components different from each other, it is necessary to wash the respective devices provided in the filtration device, the pipes, the solution casting apparatus, and the like, and to draw the solvent from the waste produced by the washing process. Thereby, the solvent can be reused. Further, it is necessary to wash the casting chamber, the drying chamber, and the recovery device for the purpose of preventing foreign substances contained in the dope therein from mixing with a casting film and a wet film formed from a new dope, and to remove the solvent from the waste produced by the washing process

In a case where the solvent is drawn from the waste, in general, the waste is subjected to a heating process or the like to evaporate the solvent contained in the waste. However, when the waste is heated at a high temperature for many hours, acid is produced by hydrolysis of the polymer, additive, and solvent contained in the waste. As a result, it is impossible to recover the solvent suitable for being reused for a new dope preparation. On the contrary, when the waste is heated at a low temperature, it takes longer time to evaporate the solvent, and therefore resulting in an insufficient method for efficiently removing the solvent from a large amount of waste.

Further, in view of improving efficiency of evaporating solvent contained in the waste, the waste maybe cast onto a support and heated thereon. However, in such a case, the support need to be very large to remove the solvent from a large amount of waste. Using such a large support is not preferable, because installation space for the drying device and size thereof become huge. On the contrary, when the waste is poured into a bath having a predetermined depth to be dried therein for the purpose of preventing increase in size of the installation space for the drying device and the like, the solvent on and around the surface of the waste exposed to the outside preferentially evaporates. Accordingly, it takes longer time for all the solvent to evaporate from the waste stored in the bath. Therefore, it is impossible to efficiently evaporate the solvent from the waste.

### SUMMARY OF THE INVENTION

In view of the above, an object of the present invention is to provide a method for removing solvent from a polymer solution, and in particular a method for efficiently removing solvent capable of being reused for preparing a dope from waste discharged from a dope contact line in which the dope is prepared or through which the dope passes, a solution casting apparatus, and the like.

To achieve the above object, according to the present invention, there is provided a solvent removing method for removing a first solvent from a first dope, the first dope including a first polymer, the first solvent, and a first additive and being remained in a dope contact line, and the dope contact line being used for preparing a dope or causing the dope to pass therethrough. According to the solvent removing method of the present invention, a second dope is introduced into the dope contact line to substitute the second dope with waste containing the first dope remained in the dope contact line. The second dope includes at least one of a second polymer different from the first polymer, a second solvent different from the first solvent, and a second additive different from the first additive. The waste is disposed in a small-volume substance having a molar volume smaller than that of a liquid compound constituting the first solvent. The first solvent is evaporated from the waste.

It is preferable that a washing liquid for removing the first dope is introduced into the dope contact line before the introducing of the second dope, and the waste containing the washing liquid is discharged from the dope contact line. Further, a surface of the waste and an area around the surface are preferably in a falling-rate drying state.

Preferably, the waste is disposed in gas containing the small-volume substance. A weight of the small-volume substance contained in the gas is preferably not less than 0.3 MS and not more than MS, the MS being an amount of saturated vapor of the small-volume substance contained in the gas. Further, a temperature of the gas is preferably not less than a boiling point (° C.) of the small-volume substance and not more than three times as the boiling point (° C.).

It is preferable that the waste is disposed in a liquid containing the small-volume substance. Further, a temperature of the liquid is preferably not less than a boiling point (° C.) of the first solvent and not more than the boiling point (° C.) of the small-volume substance.

It is preferable that the first solvent consists of plural compounds, and among the plural compounds, a compound having the smallest molar volume is the liquid compound. Further, the first solvent preferably contains at least one of dichloromethane, methanol, and butanol, and the small-volume substance contains at least one of water, methanol, acetone, and methyl ethyl ketone.

Accordingly, according to the solution casting method of the present invention, the waste is disposed in the small-volume substance having a molar volume smaller than that of the liquid compound constituting the solvent contained in the waste, and the solvent evaporates from the waste. Therefore, it is possible to efficiently evaporate the solvent from the waste. In particular, even if the amount of liquid compounds contained on and around the surface of the waste is in a slightly falling-rate drying state, since the diffusion of the liquid compounds contained in the waste is accelerated, the liquid compounds deep inside of the waste easily reach the surface and an area around the surface of the waste. Accordingly, it is possible to easily evaporate the solvent from the waste.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is an explanation view schematically illustrating a waste liquid disposing apparatus for drawing refined solvent from a waste liquid, a dope producing apparatus, and a solution casting apparatus according to an embodiment of the present invention;

FIG. 2 is an explanation view schematically illustrating a solvent removing device;

FIG. 3 is an explanation view schematically illustrating a wet gas supplying section;

FIG. 4 is an explanation view schematically illustrating time required for a drying process in which a waste liquid just after being recovered from a dope contact line turns into a residue, and a transition in an amount of residual solvent; and

FIG. 5 is an explanation view schematically illustrating a wet heating chamber according to another embodiment of the present invention.

### DESCRIPTION OF THE PREFERRED EMBODIMENTS

Embodiments of the present invention are described hereinbelow. The present invention, however, is not limited to the following embodiments.

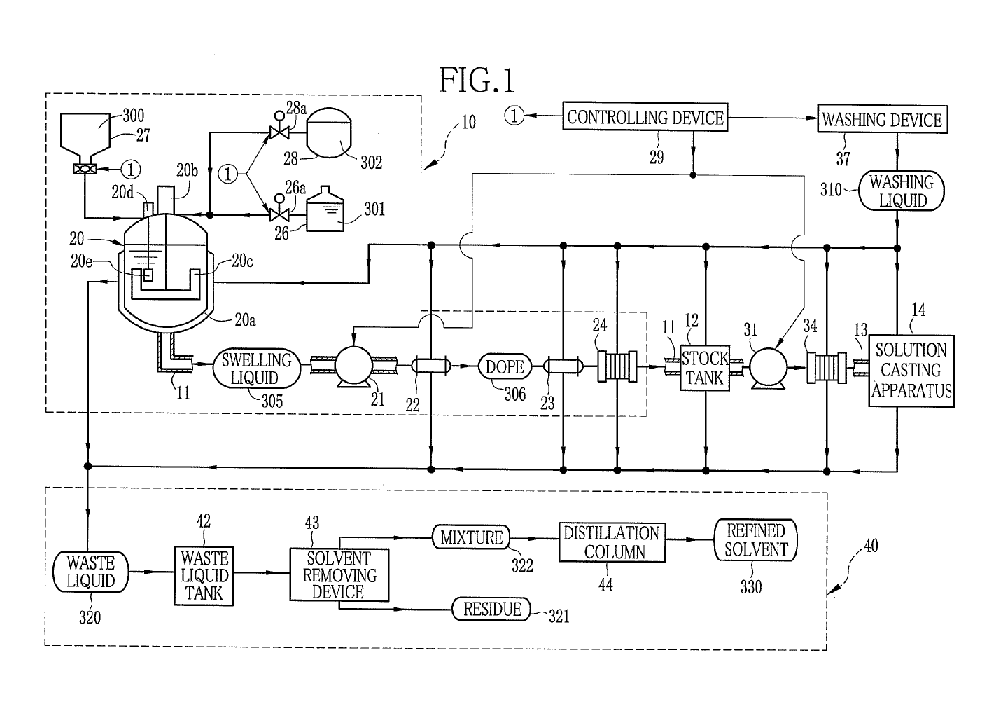

As shown in FIG. 1, a dope producing apparatus 10 is connected to a stock tank 12 through a first pipe 11. The stock tank 12 is connected to a solution casting apparatus 14 through a second pipe 13. The dope contained in a dissolving tank 20 is guided to the downstream side through the first pipe 11. The dope to be cast is guided to the solution casting apparatus 14 through the second pipe 13.

The dope producing apparatus 10 includes the dissolving tank 20, a pump 21, a heating device 22, a temperature controller 23, a filtration device 24, and the like which are disposed along the first pipe 11 in this order from an upstream side. To the dissolving tank 20 are connected a solvent tank 26, a hopper 27, and an additive tank 28 through each pipe. A pipe for connecting the solvent tank 26 and the dissolving tank 20 is provided with a valve 26a. A pipe for connecting the additive tank 28 and the dissolving tank 20 is provided with a valve 29a. A controlling device 29 performs controlling such that the valves 26a and 28a respectively shift to one of an opening position and a closing position.

The controlling device 29 controls the hopper 27 such that the hopper 27 supplies a TAC 300 to the dissolving tank 20. The solvent tank 26 stores solvent 301, and the additive tank 28 stores an additive 302. When the valve 26a is set to the opening position, the solvent 301 starts to be supplied to the dissolving tank 20 from the solvent tank 26. When the valve 26a is set to the closing position, the solvent 301 stops being supplied to the dissolving tank 20 from the solvent tank 26. In the similar manner, when the valve 28a is set to the opening position, the additive 302 starts to be supplied to the dissolving tank 20 from the additive tank 28. When the valve 28a is set to the closing position, the additive 302 stops being supplied to the dissolving tank 20 from the additive tank 28.

The dissolving tank 20 is provided with a jacket 20a for covering an outer surface thereof, a first stirrer 20c rotated by a motor 20b. Additionally, the dissolving tank 20 is preferably provided with a second stirrer 20e rotated by a motor 20d. Note that the first stirrer 20c is preferably provided with an anchor blade, and the second stirrer 20e is preferably a stirrer of dissolver type. The temperature inside the dissolving tank 20 is preferably adjusted within a predetermined range by pouring a heat transfer medium into the jacket 20a. In the dissolving tank 20, a liquid containing the TAC 300, the solvent 301, and the additive 302 is heated at a temperature within a predetermined range, and the first stirrer 20c and the second stirrer 20e are arbitrarily selected and rotated to prepare a swelling liquid 305 in which the TAC 300 is swelled in the solvent 301.

The swelling liquid 305 prepared in the dissolving tank 20 is supplied to the heating device 22 with use of a pump 21. Preferably, the heating device 22 includes a pipe provided with a jacket, and applies pressure to the swelling liquid 305. The swelling liquid 305 is heated by the heating device 22 to prepare the dope 306 in which the TAC 300 is dissolved into the solvent 301. The temperature controller 23 keeps the temperature of the prepared dope 306 approximately constant within a predetermined range. Thereafter, the dope 306 is filtered by the filtration device 24 to remove impurities therefrom. An average diameter of the pores of a filtration filter used for the filtration device 24 is preferably not more than 100 μm. The filtering flow volume of the dope is preferably at least 50 L/h.

The dope 306 prepared in-the dope producing apparatus 10 is stored in the stock tank 12, and the temperature of the dope 306 is kept approximately constant within a predetermined range in the stock tank 12. Further, the second pipe 13 is provided with a pump 31 for sending the dope 306 stored in the stock tank 12, and a filtration device 34. In the solution casting apparatus 14, the dope 306 which has been sent with use of the pump 31 and passed through the filtration device 34 is cast onto a support through a casting die in a casting chamber. Thereby, a casting film is formed and dried on the support. Upon being hardened enough to have strength for self-supporting property, the casting film is peeled from the support to be sent as a wet film to a drying chamber. The wet film is subjected to a drying process in the drying chamber to be a film.

The washing device 37 is connected to the controlling device 29. The controlling device 29 performs controlling such that the washing device 37 supplies a washing liquid 310 to the dope producing apparatus 10, the first pipe 11, the stock tank 12, the second pipe 13, the solution casting apparatus 14, and the filtration device 24. Hereinafter, the components constituting each of the dope producing apparatus 10 and the solution casting apparatus 14, and further, the stock tank 12, the filtration device 24, the first pipe 11, the second pipe 13, and the like are collectively referred to as a dope contact line. Upon detecting a dope changing signal from a not-shown signal outputting device, the controlling device 29 sets each of the valves 26a and 28a to the closing position. Thus, the TAC 300 stops being supplied from the hopper 27, and the operation of each of the pumps 21 and 31 stops. Thereafter, the washing device 37 supplies the washing liquid 310 to the dope contact line.

A waste liquid disposing apparatus 40 includes a waste liquid tank 42, a solvent removing device 43, and distillation column 44. A waste liquid 320 containing the washing liquid 310 and the dope 306 remained in the dope contact line is recovered from the dope contact line by the waste liquid tank 42. In the solvent removing device 43, the waste liquid 320 is subjected to a predetermined process, and thereby the waste liquid 320 is separated into a residue 321 containing the TAC 300, the additive 302, and the like, and a mixture 322 containing the solvent 301. In the distillation column 44, fractional distillation is performed. In the fractional distillation, the mixture 322 in a liquid-state is distilled to draw refined solvent 330 capable of being used for preparing a new dope out of the mixture 322. Note that the residue 321 is discarded without being processed, or subjected to a predetermined process to be used as a material for cement, or a raw material for combustion improver and activated carbon. Further, after the TAC 300 is separated from the residue 321, the residue 321 can be used as a material for preparing the dope.

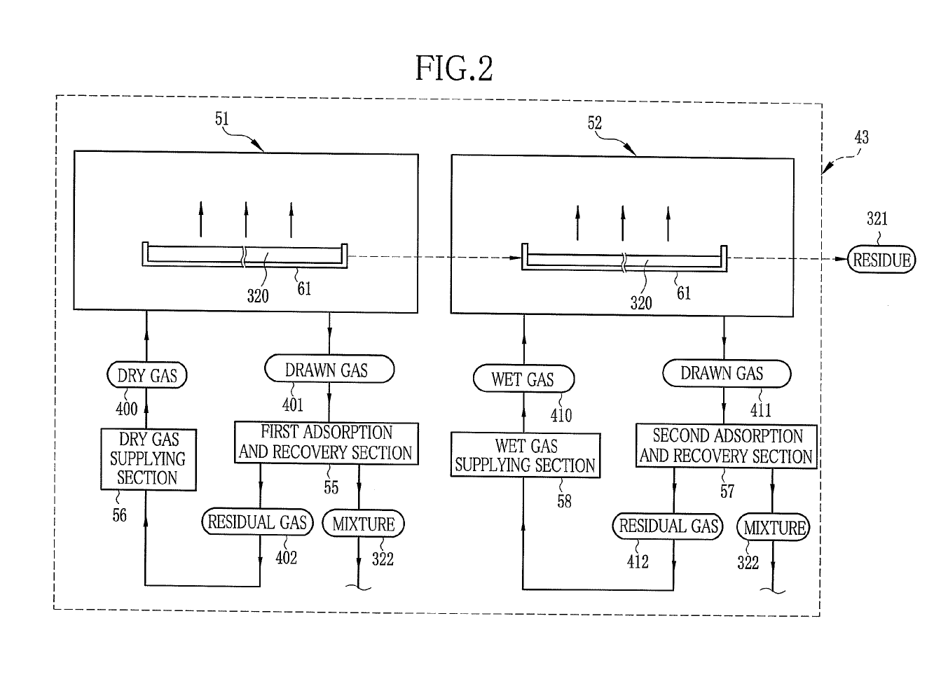

As shown in FIG. 2, the solvent removing device 43 includes a dry heating chamber 51 and a wet heating chamber 52. The dry heating chamber 51 is provided with a not-shown duct. A first adsorption and recovery section 55 and a dry gas supplying section 56 are connected to the heating chamber 51 through the duct. The wet heating chamber 52 is provided with a not-shown duct. A second adsorption and recovery section 57 and a wet gas supplying section 58 are connected to the wet heating chamber 52 through the duct.

The dry heating chamber 51 is filled with dry gas 400. The first adsorption and recovery section 55 recovers the dry gas 400 from the dry heating chamber 51 as a drawn gas 401 through the duct. Next, in the first adsorption and recovery section 55, the solvent 301 is adsorbed by an adsorbent such as the activated carbon from the drawn gas 401 during an adsorption process. Further, in the first adsorption and recovery section 55, the solvent 301 adsorbed by the adsorbent during the adsorption process is desorbed with use of steam during a desorption process. Due to the adsorption process and the desorption process, the mixture 322 containing water and the solvent 301 is generated from the drawn gas 401, and the mixture 322 is sent to the distillation column 44 (see FIG. 1). On the contrary, the drawn gas 401 from which the solvent 301 is removed during the desorption process is sent as a residual gas 402 to the dry gas supplying section 56. In the dry gas supplying section 56, temperature and humidity of the recovered residual gas 402 are adjusted within a predetermined range. Thereafter, the residual gas 402 is supplied as the dry gas 400 to the dry heating chamber 51 through the duct. Further, the dry heating chamber 51 includes a waste liquid reservoir 61. The waste liquid 320 stored in the waste liquid tank 42 is poured into the waste liquid reservoir 61. Thus, in the dry heating chamber 51, dry heating process is performed. In the dry heating process, the waste liquid 320 is heated in the dry gas 400 whose temperature and humidity are respectively adjusted within a predetermined range.

The wet heating chamber 52 is filled with a wet gas 410. At first, the second adsorption and recovery section 57 recovers the wet gas 410 from the wet heating chamber 52 as a drawn gas 411 through the duct. Next, in the second adsorption and recovery section 57, the solvent 301 is adsorbed by the adsorbent such as the activated carbon from the drawn gas 411 during the adsorption process. Further, in the second adsorption and recovery section 57, the solvent 301 adsorbed by the adsorbent during the adsorption process is desorbed with use of steam during the desorption process. Due to the adsorption process and the desorption process, the mixture 322 containing water and the solvent 301 is generated from the drawn gas 411, and the mixture 322 is sent to the distillation column 44 (see FIG. 1). On the contrary, the drawn gas 411 from which the solvent 301 is removed during the desorption process is sent as a residual gas 412 to the wet gas supplying section 58. In the wet gas supplying section 58, temperature and humidity of the recovered residual gas 412 are adjusted within a predetermined range. Thereafter, the residual gas 412 is supplied as the wet gas 410 to the wet heating chamber 52 through the duct. Further, the wet heating chamber 52 includes the waste liquid reservoir 61. The waste liquid 320 subjected to the dry heating process is poured into the waste liquid reservoir 61. Thus, in the wet heating chamber 52, wet heating process is performed. In the wet heating process, the waste liquid 320 is heated in the wet gas 410 whose temperature and humidity are respectively adjusted within a predetermined range.

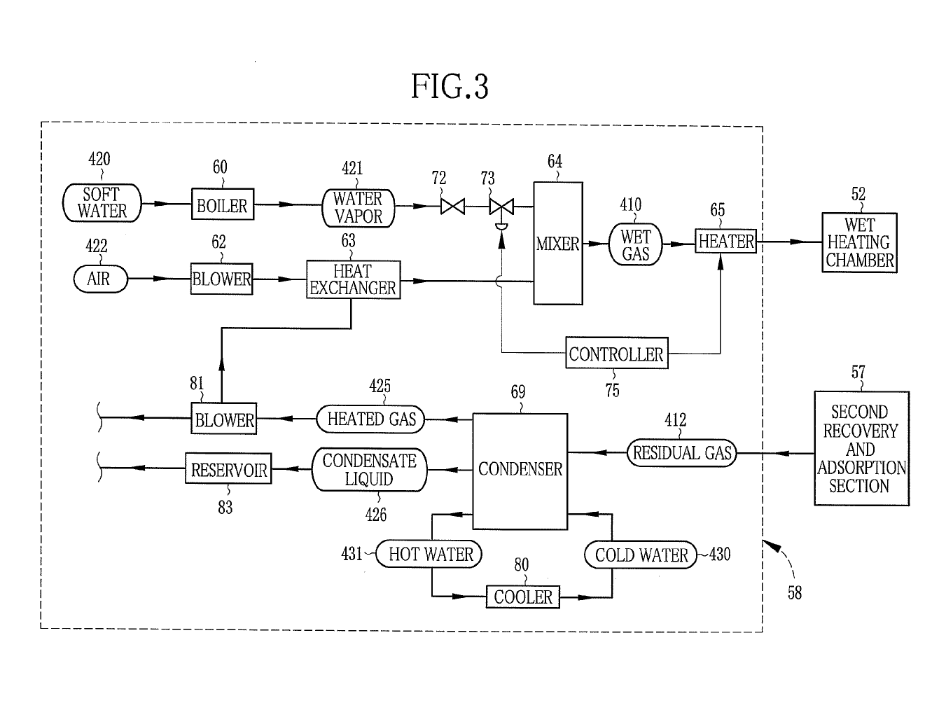

As shown in FIG. 3, the wet gas supplying section 58 includes a boiler 60, a blower 62, a heat exchanger 63, a mixer 64, a heater 65, and a condenser 69. The boiler 60 heats soft water 420 to form water vapor 421. The blower 62 sends air 422 to the heat exchanger 63. The heat exchanger 63 heats the air 422 sent by the blower 62. The mixer 64 mixes the water vapor 421 and the air 422 having passed through the heat exchanger 63 to form the wet gas 410. The heater 65 heats the wet gas 410 and sends the heated wet gas 410 to the wet heating chamber 52. The condenser 69 condenses the recovered residual gas 412 which is recovered from the second adsorption and recovery section 57 to form heated gas 425 and a condensate liquid 426.

A pipe connecting the boiler 60 and the mixer 64 is provided with a pressure reducing valve 72 and a flow control valve 73. The pressure reducing valve 72 decompresses the water vapor 421 to have a predetermined pressure. The flow control valve 73 controls flow volume of the water vapor 421. Further, the controller 75 is connected to the flow control valve 73 and the heater 65. The controller 75 adjusts the humidity and temperature of the wet gas 410 within a predetermined range. The humidity and temperature of the wet gas 410 may be adjusted based on a value read by a humidity sensor (not shown) provided in the wet heating chamber 52. Alternatively, the humidity and temperature of the wet gas 410 may be adjusted based on the conditions in the wet heating process.

A cooler 80 is connected to the condenser 69. The cooler 80 sends cold water 430 to the condenser 69. The cold water 430 sent to the condenser 69 is used to condense the residual gas 412. Due to the condensation of the residual gas 412, the cold water 430 turns into hot water 431. In the cooler 807 the recovered hot water 431 is subjected to a cooling process and sent again to the condenser 69 as the cold water 430. Part of the heated gas 425 generated by the condenser 69 is sent to the heat exchanger 63 by a blower 81, and the heat of the heated gas 425 is reused. A redundant amount of the heated gas 425 is discarded.

The condensate liquid 426 generated by the condenser 69 is sent to a reservoir 83. The reservoir 83 is provided with a concentration detector for detecting the concentration of the solvent in the condensate liquid 426. When the concentration of the solvent in the condensate liquid 426 is a predetermined value or less, the condensate liquid 426 is subjected to a predetermined process to be discarded. Note that in a case where the concentration of the solvent in the condensate liquid 426 exceeds a predetermined value, the condensate liquid 426 may be supplied as the mixture 322 to the distillation column 44 (see FIG. 1).

By referring to FIG. 1, the operation of the present invention is described. At first, the controlling device 29 sets each of the valves 26a and 28a to the opening position. The solvent 301 is sent from the solvent tank 26 to the dissolving tank 20. The additive 302 is sent from the additive tank 28 to the dissolving tank 20. The TAC 300 is sent from the hopper 27 to the dissolving tank 20. The temperature inside the dissolving tank 20 is adjusted within the range of −10° C. to 55° C. by the jacket 20a. The first stirrer 20c and the second stirrer 20e are arbitrarily selected and rotated to prepare the swelling liquid 305 from the liquid containing the TAC 300, the solvent 301, and the additive 302.

The swelling liquid 305 is supplied to the heating device 22 with use of the pump 21. While the swelling liquid 305 is heated or while the swelling liquid 305 is pressurized and heated, the TAC 300 is dissolved into the solvent 301 to prepare the dope 306. Note that, the preferable temperature range of the swelling liquid 305 is not less than −100° C. and not more than −10° C., or not less than 0° C. and not more than 120° C. A heating-dissolving method and a cooling-dissolving method are arbitrarily selected to be performed, and thereby the TAC 300 can be dissolved into the solvent 301 sufficiently. The temperature of the dope 306 is regulated by the temperature controller 23 such that the temperature of the dope 306 becomes not less than 0° C. and not more than 40° C. Thereafter, the dope 306 is filtered by the filtration device 24 to remove impurities therefrom. The dope 306 after filtration is supplied to the stock tank 12 via a not-shown valve.

By the methods described above, the dope 306 having the TAC concentration of not less than 5 wt % and not more than 40 wt % can be prepared. More preferably, the TAC concentration is not less than 15 wt % and not more than 30 wt %, and most preferably not less than 17 wt % and not more than 25 wt %. Further, the concentration of the additive 302 (mainly plasticizer) is preferably within the range of 1 wt % to 30 wt % when the whole solid content in the dope 306 is considered as 100 wt %.

The dope 306 prepared in the dope producing apparatus 10 is stored in the stock tank 12. The dope 306 stored in the stock tank 12 passes through the filtration device 34 and is supplied to the solution casting apparatus 14 with use of the pump 31. The film as the final product is produced from the dope 306 in the solution casting apparatus 14 by the solution casting method.

Next, in the dope producing apparatus 10 in which the dope 306 is prepared, changing from the dope 306 to a new dope containing another polymer instead of the TAC 300 is performed. The details about the respective devices for use in the changing are as follows. At first, a dope changing signal is sent to the controlling device 29 by a not-shown signal outputting device. Upon detecting the dope changing signal sent from the not-shown signal outputting device, the controlling device 29 sets each of the valves 26a and 28a to the closing position. Thereby, the TAC 300 stops to be supplied to the dissolving tank 20 from the hopper 27, and the operation of each of the pumps 21 and 31 is stopped.

Thereafter, the washing device 37 supplies the washing liquid 310 to the dope contact line. The washing liquid 310 supplied to the dope contact line is discharged together with the swelling liquid 305 and the dope 306 remained in the dope contact line as the waste liquid 320 from the dope contact line. Thereby, the washing process is performed. After the swelling liquid 305 and the dope 306 remained in the dope contact line are sufficiently removed therefrom, the washing device 37 stops supplying the washing liquid 310 to the dope contact line. Thereby, the washing process finishes. The solid content concentration of the waste liquid 320 discharged in the washing process is not less than 0.1 wt % and not more than 25 wt %. Note that solid content concentration means the concentration of the polymer and the additive contained the waste liquid 320.

When the washing process by the washing device 37 is finished, the dope changing signal is again sent to the controlling device 29 by the not-shown signal outputting device. Upon detecting the dope changing signal, the controlling device 29 sets each of the valves 26a and 28a to the opening position. Thereby, a new polymer starts to be supplied to the dissolving tank 20 from the hopper 27, and the operation of each of the pumps 21 and 31 is started. Thereby, a new dope is prepared in the dope producing apparatus 10, and a film different from a primary film can be produced from the new dope in the solution casting apparatus 14.

Next, the refined solvent 330 is drawn from the waste liquid 320 produced in the washing process. The details thereof are as follows. As shown in FIGS. 1 and 2, after the washing process is started, the waste liquid tank 42 recovers the waste liquid 320 discharged from the dope contact line. The waste liquid 320 contains the washing liquid 310 and the swelling liquid 305 or the dope 306 remained in the dope contact line.

The waste liquid tank 42 supplies the waste liquid 320 to the waste liquid reservoir 61 provided in the dry heating chamber 51. The dry gas supplying section 56 supplies the dry gas 400 adjusted at a temperature within the range of 40° C. to 150° C. to the dry heating chamber 51, and thereby dry heating process is performed in the dry heating chamber 51. Due to the heat drying process, the solvent 301 evaporates from the waste liquid 320. The evaporated solvent (solvent vapor) 301 is recovered as the drawn gas 401 by the first adsorption and recovery section 55, and then subjected to the adsorption and desorption processes, to be the mixture 322.

After the dry heating process, the waste liquid reservoir 61 containing the waste liquid 320 is guided to the wet heating chamber 52. The wet gas supplying section 58 supplies the wet gas 410, whose temperature and humidity are each adjusted to an approximately constant value within a predetermined range, to the wet heating chamber 52. Then, the wet heating process is performed in the wet heating chamber 52. Due to the wet heating process, the solvent 301 evaporates from the waste liquid 320. The solvent vapor 301 is recovered as the drawn gas 411 by the second adsorption and recovery section 57, and the subjected to the adsorption and desorption processes, to be the mixture 322.

The mixture 322 produced in the adsorption and desorption processes by the first and second adsorption and recovery sections 55 and 57 is supplied to the distillation column 44. In the distillation column 44 the mixture 322 is subjected to the fractional distillation to produce the refined solvent 330. The refined solvent 330 is used as solvent for preparing a new dope. On the contrary, due to the dry heating process and the wet heating process, the solvent 301 evaporates from the waste liquid 320 in the waste liquid reservoir 61. At the final stage, the residue 321 remains in the waste liquid reservoir 61. The residue 321 generated due to the dry heating process and wet heating process is subjected to a predetermined process and discarded or reused.

Next, the evaporation of the solvent 301 by the dry heating process and the wet heating process is described in detail. The waste liquid 320 containing a sufficient amount of compound for the solvent 301 (namely, solvate, hereinafter referred to as liquid compound, and the liquid compound is not a compound of high order generated between molecules of solute or between ions, but a compound constituting the solvent in the present invention) is subjected to the dry heating process, and then the liquid compound contained in an area on and around the liquid level of the waste liquid 320 (hereinafter referred to as a liquid surface area) are emitted outside. After the dry heating process is performed for a predetermined period of time, the liquid surface area of the waste liquid 320 turns into a state in which a little amount of liquid compound is contained therein, namely, a falling-rate drying state.

For the purpose of evaporating the liquid compounds from the waste liquid 320 whose liquid surface area is in a falling-rate drying state, the liquid compounds deep inside the waste liquid 320, which are away from the liquid surface area thereof, need to be diffused to the liquid surface area of the waste liquid 320. However, in the liquid surface area of the waste liquid 320 in a falling-rate drying state, a network structure of polymer molecules or the like is formed. The mesh of the network structure is not large enough to diffuse the liquid compounds each having a predetermined molar volume in the waste liquid 320. Therefore, in the dry heating process, it is difficult for the liquid compounds deep inside the waste liquid 320 to be diffused to the liquid surface area in the falling-rate drying state.

According the present invention, the waste liquid 320 whose liquid surface area is in the falling-rate drying state is heated in the wet gas 410 containing water molecules during the wet heating process. Therefore, the water molecules are absorbed to the liquid surface area of the waste liquid 320, and as a result, the liquid compounds can easily evaporate from the waste liquid 320. The reason is as follows. When the water molecules are absorbed through the liquid surface area of the waste liquid 320 in the falling-rate drying state, the water molecules expand the meshes of the network structure in the waste liquid 320. As the meshes are expanded, the liquid compounds deep inside the waste liquid 320 are easily diffused to reach the liquid surface area thereof. Thus, due to the wet heating process, the solvent 301 can easily evaporate from the waste liquid 320.

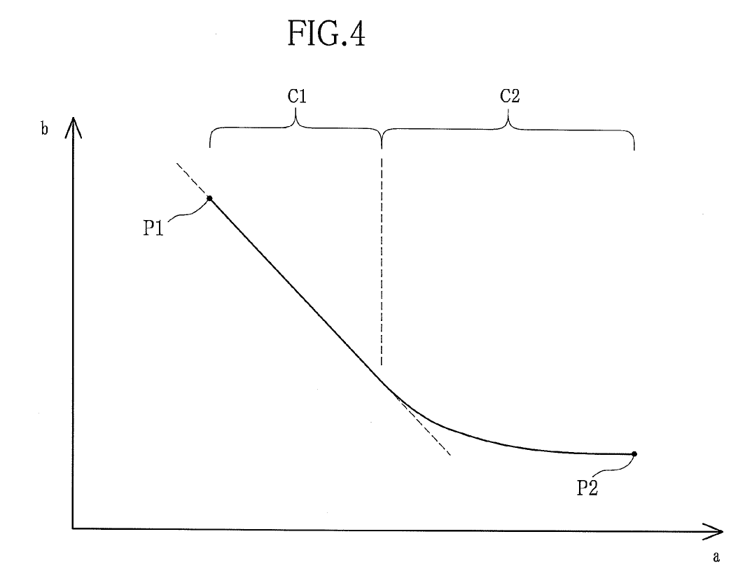

As a method for judging whether the waste liquid 320 is in the falling-rate drying state or not, there is a method for the judgment based on whether the amount of residual solvent is within a predetermined range or not, or the like. In a heating experiment under a definite condition, the evaporation speed of the solvent 301 from the waste liquid 320, namely, a state in which a gradient is approximately constant as shown in a plot of FIG. 4 may be referred to as a constant-rate drying state C1. The state after the constant-rate drying state C1 may be referred to as a falling-rate drying state C2. The plot of FIG. 4 shows total time required for the dry heating process and the wet drying process in which the residue 321 is generated from the waste liquid 320 just after being recovered from the dope contact line (namely, elapsed time), and change in the amount of the residual solvent. An a-axis denotes the length of elapsed time, and a b-axis denotes the residual amount of the solvent. A point P1 in FIG. 4 denotes the waste liquid 320 just after being recovered from the dope contact line, and a point P2 in FIG. 4 shows the residue 321 generated due to the dry heating process and the wet heating process. Note that instead of using the plot in FIG. 4, for example, a state in which the amount of residual solvent is 100 wt % or less on a dry basis may be referred to as the falling-rate drying state C2. The residual amount of solvent on a dry basis is a value calculated by a formula: [(x−y)/y]×100, in which x is weight of a sample at the time of sampling and y is weight of the sample after being dried.

In order to accelerate diffusing of the liquid compounds in the waste liquid 320, in general, it is necessary to dispose the waste liquid 320 at a temperature not less than a constant value (approximately 110° C.) for a long time (for example not less than 24 hours). However, according to the present invention, it is possible to accelerate diffusion of the liquid compounds in the waste liquid 320 such that the solvent 301 can easily evaporate from the waste liquid 320 without performing the above-described process for a long time, thus causing excellent efficiency in view of energy. Further, the wet heating process at a high temperature for a long time causes hydrolysis of the solvent 301. However, according to the present invention, since it is possible to prevent the hydrolysis of the solvent 301, the solvent 301 having excellent quality can be obtained.

As the washing liquid 310, it is preferable that the washing liquid 310 can dissolve the polymer, such as the TAC 300. Concretely, the solvent 301 contained in the dope 306 or the solvent contained in the new dope is preferably used.

A depth D from the liquid level of the waste liquid 320 to the bottom surface inside the waste liquid reservoir 61 at the time of wet heating process preferably does not exceed the depth enabling the water molecules to enter the waste liquid 320. Concretely, the depth D is preferably at most 30 cm. Note that, the same holds true for the case in which the waste liquid 320 is in a gel state or solid state.

A larger number of water molecules, higher relative humidity, and the like are given as preferable conditions for the wet gas 410 for use in the wet heating chamber 52.

When the amount of saturated vapor of water molecules in the wet gas 410 is denoted by MS, a weight of the water molecules contained in the wet gas 410 is preferably not less than 0.3 MS and not more than MS, and more preferably not less than 0.31 MS and not more than 0.5 MS. In a case where the amount of the water molecule contained in the wet gas 410 is less than 0.3 MS, since the amount of the water molecules is low, the meshes of the network structure of the polymer molecules are not expanded sufficiently. As a result, it becomes difficult to sufficiently evaporate the solvent 301 from the waste liquid 320, and thus leading to unfavorable result.

When a boiling point of the small-volume substance described later is denoted by BP (° C.), the temperature of the wet gas 410 is preferably not less than BP (° C.) and not more than 3 BP (° C.), more preferably not less than BP (° C.) and not more than 2 BP (° C.), and most preferably not less than 1.1 BP (° C.) and not more than 1.7 BP (° C.). When the temperature of the wet gas 410 exceeds 200° C., hydrolysis of the solvent 301 occurs, thus causing unfavorable result.

Although the soft water 420 is used as the component of the wet gas 410 in the above embodiment, the present invention is not limited thereto. Other small-volume substance may be used. Note that, the small-volume substance means a substance having molar volume smaller than that of the liquid compound for the solvent 301 contained in the dope 306. As the molar volume of the small-volume substance becomes smaller in comparison with the mesh of the network structure, the mesh of the network structure is expanded more and more, and as a result, the effect of accelerating diffusion of the liquid compounds is prominently exerted. The molar volume of the small-volume substance depends on the composition of the polymer, however it is preferably in the range of 5 (cm³/mol) to 150 (cm³/mol), and more preferably in the range of 10 (cm³/mol) to 100 (cm³/mol) under the atmosphere at the temperature of 0° C. and at the atmosphere pressure of 1 atm.

Further, when the small-volume substance has compatibility with the solvent 301, since the solvent 301 is dissolved into the small-volume substance, the liquid compound is easily diffused in the waste liquid 320 in the falling-rate drying state, thus causing a favorable result.

As the small-volume substance, concretely, the water molecule, the organic compound, or a mixture of them may be used. The soft water, hard water, pure water, and the like, which contains the water molecule, may be also used. Note that the pure water used in the present invention has electrical resistivity of at least 1 MΩ. The concentration of metal ion such as natrium ion, kalium ion, magnesium ion, and calcium ion contained in the pure water is less than 1 ppm, and the concentration of anion such as chlorine ion and nitric acid ion contained in the pure water is less than 0.1 ppm. The pure water can be easily obtained by reverse osmosis membrane, ion exchange resin, distillation, or combination of them.

Organic compound used as the small-volume substance is methanol, acetone, methyl ethyl ketone, or the like.

Further, in a case where the solvent contained in the casting dope 306 consists of a single compound, the single compound is the liquid compound. In a case where the solvent 301 contained in the casting dope 306 is mixture of plural compounds, the compound whose molar volume is smallest among the compounds to be drawn may be the liquid compound.

Although the air 422 is used in the above embodiment, the present invention is not limited thereto. Instead of the air 422, inert gas such as nitrogen, He, and Ar may be used in the present invention. Note that the amount of impurities contained in the air 422 is preferably as few as possible as in the case of the small-volume substance.

Although the wet heating process is performed after the dry heating process in the above embodiment, the present invention is not limited thereto. Only the wet heating process may be performed. Additionally, although the waste liquid 320 is heated in the dry heating process and the wet heating process in the above embodiment, the present invention is not limited thereto. The waste liquid 320 may be disposed in the atmosphere in which the solvent 301 evaporates from the waste liquid 320. Moreover, although the dry heating process is performed in the dry heating chamber 51 and the wet heating process is performed in the wet heating chamber 52 in the above embodiment, the present invention is not limited thereto. An adjustment device capable of adjusting the atmosphere in the heating chamber to the same conditions as those of the dry gas 400 and the wet gas 410 may be provided in the drying chamber. The drying chamber provided with the above-described adjustment device makes it possible to perform the dry heating process and the wet heating process successively.

Although the waste liquid 320 containing the washing liquid 310 and the dope 306 is recovered and the solvent 301 is removed from the waste liquid 320 in the above embodiment, the present invention is not limited thereto. The present invention is also applicable to a case in which solvent is removed from the waste containing the solvent. As the waste described above, for example, there are waste produced by evaporating the air evacuated from the drying chamber or the like in the solution casting apparatus 14 for drying the casting film and the wet film, a waste film discarded from the solution casting apparatus 14, and the like.

The waste liquid 320 in the above embodiment is not limited to the liquid. As the waste, only the liquid level or the liquid surface area of the waste may be turned into a gel state or hardened. Alternatively, whole the waste may be turned into a gel state or hardened.

The dry heating chamber 51 and the wet heating chamber 52 may be provided with plural waste liquid reservoirs 61 for storing the waste liquid 320 to perform the dry heating process or the wet heating process.

Although the dope 306 is a first dope remained in the dope contact line in the above embodiment, the first dope of the present invention is not limited thereto. The first dope of the present invention also includes a liquid in which the TAC 300 has not been dissolved or swelled in the solvent 301 yet after being supplied to the dissolving tank 20, or the swelling liquid 305.

Although the solvent 301, the additive 302, and the TAC 300 are supplied to the dissolving tank 20 in this order in the above embodiment, the order is not limited thereto. For example, after the TAC 300 is supplied to the dissolving tank 20 while its amount is measured, a desirable amount of the solvent 301 may be supplied thereto. Further, it is not always necessary to preliminarily supply the additive 302 to the dissolving tank 20, and the additive 302 may be mixed with a mixture of the TAC 300 and the solvent 301 in the following process.

Although the TAC 300 is changed to the new polymer such that the dope to be prepared in the dope producing apparatus 10 is changed to the dope having the new components in the above embodiment, the present invention is not limited thereto. It is also possible to change the solvent 301 to a new solvent, and to change the additive 302 to a new additive.

Although the washing liquid 310 is introduced into the dope contact line to wash the dope 306 or the like remained in the dope contact line in the washing process in the above embodiment, the present invention is not limited thereto. It is also possible to pour the new dope as the washing liquid 310 to the dope contact line to push away the dope remained in the dope contact line. For example, it is also possible to push away the remaining dope 306 by the washing liquid 310 introduced from the dissolving tank 20, and recover the dope 306 thus pushed away as the waste liquid 320 in the stock tank 12 or immediately before the solution casting apparatus 14. Alternatively, it is possible to introduce the washing liquid 310 from the upstream side of the first pipe 11 and the second pipe 13 and push away the remaining dope 306 and the like to the downstream side of the first pipe 11 and the second pipe 13, to recover the waste liquid 320 from the downstream side of the first pipe 11 and the second pipe 13.

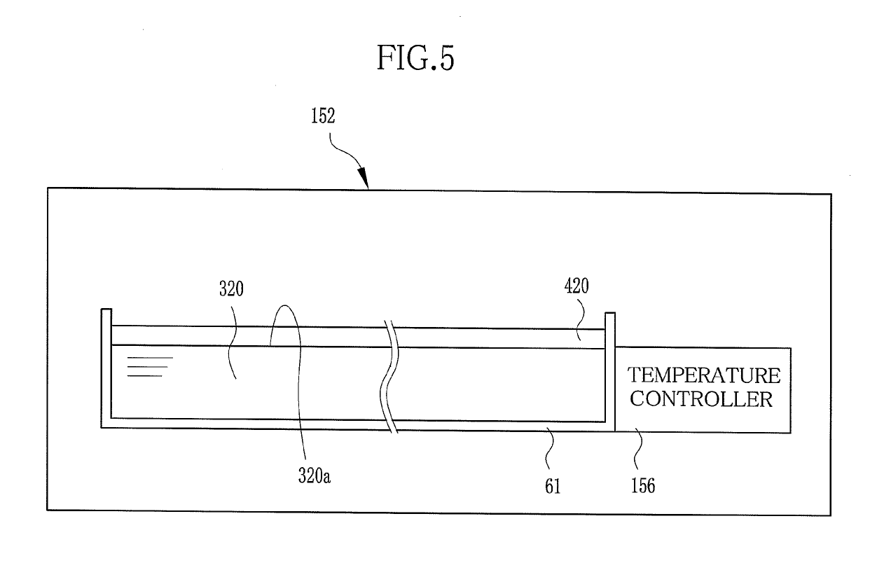

Although the wet gas 410 is used in the wet heating process in the above embodiment, the present invention is not limited thereto. Next, according to another embodiment, a wet heating chamber, in which the wet heating process is performed while the waste liquid 320 is contacted with the soft water, is described. The members and devices similar to those in the above embodiment are denoted by the same reference numerals, and the detailed description thereof will be omitted. As shown in FIG. 5, the wet heating chamber 152 is provided with the waste liquid reservoir 61. The waste liquid 320 whose surface 320a is in the falling-rate drying state is stored in the waste liquid reservoir 61. The soft water 420 adjusted to a predetermined temperature is poured onto the surface 320a by a not-shown soft water supplying device. Further, the waste liquid reservoir 61 is provided with a temperature controller 156 for adjusting the temperature of the waste liquid 320 within a predetermined range. Since the waste liquid 320 is heated to have a predetermined temperature by the temperature controller 156, the wet heating process can be performed while the soft water 420 and the waste liquid 320 are contacted with each other. Thus, in the wet heating process, it is possible to absorb the water molecules to the surface 320a of the waste liquid 320 in the falling-rate drying state, and as a result, it is possible to easily emit the liquid compound from the waste liquid 320.

The temperature of the soft water 420 is preferably not less than 40° C. and not more than 100° C., and more preferably not less than 70° C. and not more than 100° C. The temperature controller 156 preferably sets the temperature of the waste liquid 320 to not less than 40° C. and not more than 100° C., and more preferably not less than 70° C. and not more than 100° C. Note that the wet heating chamber 152 may be provided with the first adsorption and recovery section 55 and the dry gas heating section 56 to perform the wet heating process while the wet heating chamber 152 is filled with dry gas 400. Alternatively, the wet heating chamber 152 may be provided with the second adsorption and recovery section 57 and the wet gas supplying section 58 to perform the wet heating process while the wet heating chamber 152 is filled with wet gas 410.

The soft water 420 may be substituted with the hot water 431 generated by the condenser 69 (see FIG. 3) in the above embodiment. Moreover, each of the condenser 69 and the cooler 80 (see FIG. 3) may be connected with a not-shown bath by an independent pipe, for the purpose of using the heat energy obtained from the residual gas 412 (see FIG. 3) by the condenser 69 to control the temperature of the soft water 420 through the hot water 431.

Note that although the TAC 300 is used as the polymer for preparing the dope 306 in the dope producing apparatus 10 in the above embodiment, according to the present invention, the polymer is not limited to the TAC 300, and the organic compound, other cellulose acylate, and the like may be also used.

(Polymer)

Cellulose acylate is used as a polymer in this embodiment. Especially preferable cellulose acylate is triacetyl cellulose (TAC). In the cellulose acylate, it is preferable that the degree of the acyl substitution for hydrogen atoms in hydroxyl groups in cellulose satisfies all of the following formulae (I) to (III):

2.5≦A+B≦3.0 (I)

0≦A≦3.0 (II)

0≦B≦2.9 (III)

In the above formulae (I) to (III), “A” represents a degree of substitution of the hydrogen atom in the hydroxyl group to the acetyl group in cellulose, while “B” represents a degree of substitution of the hydrogen atom in the hydroxyl group to the acyl group with 3 to 22 carbon atoms in cellulose. Preferably, at least 90 wt % of TAC particles has a diameter in the range of 0.1 mm to 4 mm, respectively. Note that, the polymer capable of being used in the present invention is not limited to cellulose acylate. The polymer may be any well-known substance as long as the substance can be dissolved into the solvent and serve as a dope.

Cellulose has glucose units making β-1,4 bond, and each glucose unit has a liberated hydroxyl group at second, third, and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third, and the sixth positions in cellulose (when the whole (100%) of the hydroxyl group at the same position is substituted, the degree of substitution at this position is 1).

The total degree of substitution for the acyl groups, namely DS2+DS3+DS6, is preferably in the range of 2.00 to 3.00, more preferably in the range of 2.22 to 2.90, and most preferably in the range of 2.40 to 2.88. In addition, DS6/(DS2+DS3+DS6) is preferably at least 0.28, more preferably at least 0.30, and most preferably in the range of 0.31 to 0.34. Note that DS2 is the degree of substitution of the hydrogen atom in the hydroxyl group at second position per glucose unit to the acyl group (hereinafter referred to as a degree of acyl substitution at second position), DS3 is the degree of substitution of the hydrogen atom in the hydroxyl group at third position per glucose unit to the acyl group (hereinafter referred to as a degree of acyl substitution at third position), and DS6 is the degree of substitution of the hydrogen atom in the hydroxyl group at sixth position per glucose unit to the acyl group (hereinafter referred to as a degree of acyl substitution at sixth position).

In the present invention, the kind of the acyl groups in cellulose acylate can be one or more. When two or more kinds of acyl groups are in cellulose acylate, it is preferable that one of them is the acetyl group. When a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.22 to 2.90, and more preferably in the range of 2.40 to 2.88. In addition, DSB is preferably at least 0.30, and more preferably at least 0.7. In the DSB, the percentage of the substitution of the hydroxyl group at the sixth position is at least 20%, preferably at least 25%, more preferably at least 30%, and most preferably at least 33%. Furthermore, the value of DSA+DSB, in which the hydroxyl group is at the sixth position in cellulose acylate, is preferably at least 0.75, more preferably at least 0.80, and most preferably at least 0.85. By using such cellulose acylate that satisfies the above conditions, a solution (dope) with excellent solubility can be prepared. Especially, since using a non-chlorine organic solvent enables production of excellent solution, it is possible to produce the solution with low viscosity and excellent filterability.

Cellulose as a material of cellulose acylate may be obtained from either linter or pulp.

According to the present invention, as for cellulose acylate, the acyl group having at least 2 carbon atoms maybe either aliphatic group or aryl group, and is not especially limited. As examples of the cellulose acylate, there are alkylcarbonyl ester, alkenylcarbonyl ester, aromatic carbonyl ester, aromatic alkylcalbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

(Solvent)

As solvent to be used for preparing the dope, there are aromatic hydrocarbon (for example, benzene, toluene, and the like), halogenated hydrocarbon (for example, dichloromethane, chlorobenzene, and the like), alcohol (for example, methanol, ethanol, n-propanol, n-butanol, diethylene glycol, and the like), ketone (for example, acetone, methyl ethyl ketone, and the like), ester (for example, methylacetate, ethylacetate, propylacetate, and the like), ether (for example, tetrahydrofuran, methyl cellosolve, and the like), and the like. Note that in the present invention the dope means a polymer solution or dispersion solution that is obtained by dissolving or dispersing the polymer in the solvent.

The halogenated hydrocarbon preferably has 1 to 7 carbon atoms, and dichloromethane is most preferable. In view of physical properties of the TAC, such as solubility, peelability of a casting film from the support, a mechanical strength of the film, and optical properties of the film, it is preferable to use at least one kind of alcohol having 1 to 5 carbon atoms together with dichloromethane. The content of alcohol is preferably in the range of 2 wt % to 25 wt %, and more preferably in the range of 5 wt % to 20 wt % relative to the whole solvent. Applicable alcohols are, for example, methanol, ethanol, n-propanol, iso-propanol, n-butanol, and the like, and especially methanol, ethanol, n-butanol, and a mixture of them are more preferable among them.

Recently, in order to reduce adverse influence on the environment to the minimum, solvent containing no dichloromethane is proposed. In this case, the solvent preferably contains ether with 4 to 12 carbon atoms, ketone with 3 to 12 carbon atoms, ester with 3 to 12 carbon atoms, and alcohol with 1 to 12 carbon atoms. The solvent also contains a mixture of them. For example, the mixed solvent contains methylacetate, acetone, ethanol, and n-butanol. Note that ether, ketone, ester, and alcohol may have a cyclic structure. A compound having at least two functional groups thereof (that is, —O—, —CO—, —COO—, and —OH) may be used as the solvent. The solvent may contain other functional groups such as alcoholic hydroxyl groups.

Details regarding cellulose acylate are described in paragraphs [0140] to [0195] in Japanese Patent Laid-Open Publication No. 2005-104148. The description is also applicable to the present invention. Further, details regarding the solvent and the additives (such as a plasticizer, a deterioration inhibitor, a UV-absorbing agent, an optical anisotropy controller, a retardation controller, dye, a matting agent, a release agent, a release improver, and the like) are also described in paragraphs [0196] to [0516] in the same publication.

The present invention is not to be limited to the above embodiments, and on the contrary, various modifications will be possible without departing from the scope and spirit of the present invention as specified in claims appended hereto.

What is claimed is:

1. A solvent removing method for removing a first solvent from a first dope, said first dope including a first polymer, said first solvent, and a first additive and being remained in a dope contact line, said dope contact line being used for preparing a dope or causing said dope to pass therethrough, said solvent removing method comprising the steps of:
introducing a second dope into said dope contact line to substitute said second dope with waste containing said first dope remained in said dope contact line, said second dope including at least one of a second polymer different from said first polymer, a second solvent different from said first solvent, and a second additive different from said first additive;
disposing said waste in a small-volume substance having a molar volume smaller than that of a liquid compound constituting said first solvent; and
evaporating said first solvent from said waste.

2. A solvent removing method as defined in claim 1, further comprising the steps of:
introducing a washing liquid for removing said first dope into said dope contact line before the introducing of said second dope; and
discharging said waste containing said washing liquid from said dope contact line.

3. A solvent removing method as defined in claim 2, wherein a surface of said waste and an area around said surface are in a falling-rate drying state.

4. A solvent removing method as defined in claim 3, wherein said waste is disposed in gas containing said small-volume substance.

5. A solvent removing method as defined in claim 4, wherein a weight of said small-volume substance contained in said gas is not less than 0.3 MS and not more than MS, said MS being an amount of saturated vapor of said small-volume substance contained in said gas.

6. A solvent removing method as defined in claim 5, wherein a temperature of said gas is not less than a boiling point (° C.) of said small-volume substance and not more than three times as said boiling point (° C.).

7. A solvent removing method as defined in claim 6, wherein said waste is disposed in a liquid containing said small-volume substance.

8. A solvent removing method as defined in claim 7, wherein a temperature of said liquid is not less than a boiling point (° C.) of said first solvent and not more than the boiling point (° C.) of said small-volume substance.

9. A solvent removing method as defined in claim 8, wherein said first solvent consists of plural compounds, and among said plural compounds, a compound having the smallest molar volume is said liquid compound.

10. A solvent removing method as defined in claim 9, wherein said first solvent contains at least one of dichloromethane, methanol, and butanol, and said small-volume substance contains at least one of water, methanol, acetone, and methyl ethyl ketone.
